(19) United States
(12) Patent Application Publication
(10) Pub. No.: US 2025/0135722 A1
(43) Pub. Date: May 1, 2025

(54) NOZZLE CALIBRATION SYSTEM AND NOZZLE CALIBRATION METHOD

(71) Applicant: Pensees Inc., Seoul (KR)

(72) Inventors: Chang Ve CHEAH, Seoul (KR); Jaewoon LEE, Seoul (KR)

(73) Assignee: Pensees Inc., Seoul (KR)

(21) Appl. No.: 18/506,309

(22) Filed: Nov. 10, 2023

(30) Foreign Application Priority Data
Nov. 1, 2023 (KR) 10-2023-0148678

(51) Int. Cl. B29C 64/393; B29C 64/209; B33Y 50/02

(52) U.S. Cl. CPC B29C 64/393; B29C 64/209; B33Y 50/02

(57) ABSTRACT

Provided is a nozzle calibration system for measuring a location of a lower end of a needle member used for a 3D printer to set the location to a reference point, in which nozzle calibration system includes a nozzle part having the needle member protruding downwards, a coupling part coupled to the nozzle part, and that moves the nozzle part upwards and downwards, a movement part coupled to the coupling part, and that moves the coupling part, a detection part that detects information on whether the needle member is located in a specific detection area located in an interior thereof, and a controller electrically connected to the coupling part and the movement part to control an operation of the coupling part and the movement part, and electrically connected to the detection part to acquire information acquired by the detection part.

### TECHNICAL FIELD

The present disclosure relates to a nozzle calibration system and a nozzle calibration method.

### BACKGROUND

A technology of creating an actual object in a 3-dimensional solid shape by using a 3D printer is called ‘3D printing’. 3D printers may create 3-dimensional objects, such as metal, plastic, and nylon, by using not only ink but also various materials, and thus, the 3D printing technology in various fields is being developed.

Among them, a development of a bio 3D printing technology, which uses biomaterials including cells to 3D-print human tissues, bones, and organs, is also being actively developed. By utilizing the bio 3D printing technology, various applications may be made, for example, outputting muscles, teeth, tissues, and organs with a 3D printer to replace damaged muscles, teeth, tissues, and organs and implanting them into a body of a person, or by combining the 3D printing technology using bio-inks cells and cell growth factors for human organs that lose functions due to aging, skin aging, hair loss and a stem cell regenerative therapy.

Meanwhile, in the case of bio 3D printing technology, disposable needles are primarily used for each printing session due to concerns about contamination and the like. Then, whenever the printing material is replaced, disposable needles are also replaced, but errors may occur depending on an extent, by which a lower part of the needle is bent.

The bio 3D printing technology involves creating biological tissues, and thus, a higher level of precision is required as compared with technologies in other fields. Accordingly, a calibration technology for calibrating an error between needles to develop bio 3D printers having further improved precision is necessary.

### SUMMARY

The present disclosure has been made to solve the above-mentioned problems occurring in the prior art while advantages achieved by the prior art are maintained intact.

An aspect of the present disclosure provides a nozzle calibration system having an improved precision by calibrating an error depending on a deflection degree of a needle, and a nozzle calibration method.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a nozzle calibration system for measuring a location of a lower end of a needle member used for a 3D printer to set the location to a reference point includes a nozzle part having the needle member protruding downwards, a coupling part coupled to the nozzle part, and that moves the nozzle part upwards and downwards, a movement part coupled to the coupling part, and that moves the coupling part, a detection part that detects information on whether the needle member is located in a specific detection area located in an interior thereof, and a controller electrically connected to the coupling part and the movement part to control an operation of the coupling part and the movement part, and electrically connected to the detection part to acquire information acquired by the detection part, and the controller performs a first movement of moving the movement part such that the needle member is located in the detection area of the detection part, and a second movement of moving the movement part in a direction crossing a movement direction of the first movement and returning the movement part such that a portion of the needle member is not located in the detection area, to calibrate an error generated due to deflection of the needle member.

In another example, the controller may be configured to set a location of the needle member in the movement direction of the first movement, which is detected through the first movement, as a first reference location, reflect a value of an error acquired through the second movement to the first reference location and set a location corresponding thereto as a second reference location, and set the second reference location as a reference point of the needle member in the movement direction of the first movement.

In another example, the detection part may include a first detection member including a first opening opened forwards and rearwards, and a first sensor that detects the needle member when the needle member passes through the first opening in a forward/rearward direction, and a second detection member including a second opening opened leftwards and rightwards, and a second sensor that detects the needle member when the needle member passes through the second opening in leftward/rightward direction.

In another example, the first movement may include a (1-1)-th movement of moving the movement part forwards or rearwards such that the movement part passes through a first detection area being an area, in which a target object is detected by the first sensor, and a (1-2)-th movement of moving the movement part leftwards or rightwards such that the movement part passes through a second detection area being an area, in which the target object is detected by the second sensor, and the second movement may include a (2-1)-th movement performed after the (1-1)-th movement, and of causing the needle member to calibrate a first error generated due to a deflection on a front side or a rear side of an upward/downward direction, and a (2-2)-th movement performed after the (1-2)-th movement, and of causing the needle member to calibrate a second error generated due to a deflection on a left side or a right side of the upward/downward direction.

In another example, the controller may be configured to set a location of the needle member in a forward/rearward direction, which is detected through the (1-1)-th movement, as a (1-1)-th reference location, reflect a value of an error acquired through the (2-1)-th movement to the (1-1)-th reference location, and set a location corresponding thereto as a forward/rearward reference point, set a location of the needle member in a leftward/rightward direction, which is detected through the (1-2)-th movement, as a (1-2)-th reference location, and reflect a value of an error acquired through the (2-2)-th movement to the (1-2)-th reference location, and set a location corresponding thereto as a leftward/rightward reference point.

In another example, the controller may be configured to control the movement part to perform a third movement of the nozzle part downwards after the second movement is ended, and the controller may be configured to set a location of the needle member in the upward/downward direction when the lower end or the needle member is located in the detection area as an upward/downward reference point.

In another example, the controller may be configured to perform the third movement after the (2-1)-th movement or the (2-2)-th movement is ended, set a location of the needle member in the upward/downward direction when the lower end of the needle member is located in the first detection area as an upward/downward reference point, when the third movement is performed after the (2-1)-th movement is ended, and set a location of the needle member in the upward/downward direction when the lower end of the needle member is located in the second detection area as an upward/downward reference point, when the third movement is performed after the (2-2)-th movement is ended.

In another example, the second movement may include a first deviation movement of moving the movement part in a direction crossing the movement direction of the first movement upwards at 45 degrees at the first reference location, and moving the movement part until the needle member is not located in the detection area, a first return movement of returning the movement part such that the needle member is located at the first reference location, after the first deviation movement, a second deviation movement of moving the movement part in a direction crossing an opposite direction to the movement direction of the first movement upwards at 45 degrees at the first reference location, and moving the movement part until the needle member is not located in the detection area, and a second return movement of returning the needle member such that the needle member is located at the first reference location, after the second deviation movement.

In another example, the controller may be configured to acquire a displacement of the needle member of the movement part during the first deviation movement and the second deviation movement, and the error may be determined based on a displacement of the first deviation movement and a displacement of the second deviation movement.

In another example, the controller may be configured to compare the displacement of the first deviation movement and the displacement of the second deviation movement, and determine a movement direction value of the first movement, which corresponds to the greater one, as an error, add the error to the first reference location when the displacement of the first deviation movement is the greater, and subtract the error from the second reference location when the displacement of the second deviation movement is the greater.

In another example, the nozzle part may include a first nozzle part having a first needle member, and a second nozzle part having a second needle member, and the coupling part may be configured to change upward/downward locations of the first nozzle part and the second nozzle part.

In another example, the controller may be configured to control the coupling part to move the first nozzle part downwards and move the second nozzle part upwards when a reference point of the first needle member is determined, and control the coupling part to move the second nozzle part downwards and move the first nozzle part upwards when a reference point of the second needle member is determined.

In another example, the controller may be configured to perform any one of the (1-1)-th movement and the (1-2)-th movement first when the reference point of the first needle member is determined, and perform the other one of the (1-1)-th movement and the (1-2)-th movement first when the reference point of the second needle member is determined.

In another example, the first sensor may include a first light receiving portion, and a first light emitting portion located on any one of a left side or a right side of the first light receiving portion, and that emits light toward the first light receiving portion, and the second sensor may include a second light receiving portion, and a second light emitting portion located on any one of a front side or a rear side of the second light receiving portion, and that emits light toward the second light receiving portion.

According to another aspect of the present disclosure, a nozzle calibration method for measuring a location of a lower end of a needle member of a nozzle part and setting a location corresponding thereto to a reference point includes a first movement operation of moving the nozzle part such that the needle member is located in a detection area of a detection part, and a second movement operation of moving the needle member in a direction crossing a movement direction of the first movement operation such that a portion of the needle member is not located in the detection area, to calibrate an error generated due to deflection of the needle member, and the detection part may be configured to detect information on whether the needle member is located in the detection area located in an interior thereof.

In another example, when it is defined that a location of the needle member is at a first reference area when the needle member is located in the detection area, the second movement operation may include a first deviation movement operation of moving the needle member in a direction crossing a direction, in which the needle member is moved, upwards at 45 degrees in the first movement operation at the first reference location, and moving the needle member until the needle member is not located in the detection area, a first return movement operation of returning the needle member to the first reference location after the first deviation movement operation, a second deviation movement operation of moving the needle member in a direction crossing an opposite direction to the direction, in which the needle member is moved, upwards at 45 degrees in the first movement operation at the first reference location, and moving the needle member until the needle member is not located in the detection area, and a second return movement operation of returning the needle member such that the needle member is located at the first reference location after the second deviation movement operation.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a nozzle calibration system according to an embodiment of the present disclosure;

FIG. 2 is a view illustrating a coupling part of a nozzle calibration system according to an embodiment of the present disclosure;

FIG. 3 is a view illustrating an operation principle of a first coupling portion and a second coupling portion of a coupling part while some configurations of the coupling part are omitted;

FIG. 4 is a view illustrating a detection part of a nozzle calibration system according to an embodiment of the present disclosure;

FIG. 5 is a view conceptually illustrating a first detection member;

FIG. 6 is a view conceptually illustrating a state, in which

a needle member performs a first movement;

FIG. 7 is a view conceptually illustrating a state, in which

a needle member performs a first deviation movement;

FIG. 8 is a view conceptually illustrating a state, in which a needle member performs a first return movement;

FIG. 9 is a view conceptually illustrating a state, in which a needle member performs a second deviation member;

FIG. 10 is a view conceptually illustrating a state, in which a needle member performs a second return movement;

FIG. 11 is a view illustrating a state, in which a first needle member performs a (1-1)-th movement;

FIG. 12 is a view illustrating a state, in which a first needle member performs a (1-2)-th movement;

FIG. 13 is a view illustrating a state, in which a first needle member performs a third movement;

FIG. 14 is a view illustrating a state, in which a second needle member performs a (1-2)-th movement;

FIG. 15 is a view illustrating a state, in which a second needle member performs a (1-1)-th movement; and

FIG. 16 is a view illustrating a state, in which a second needle member performs a third movement.

### DETAILED DESCRIPTION

Hereinafter, embodiments of the present disclosure will be described in detail with reference to the accompanying drawings. In adding reference numerals to the components of the drawings, it is noted that the same components are denoted by the same reference numerals even when they are drawn in different drawings. Furthermore, in describing the embodiments of the present disclosure, when it is determined that a detailed description of related known configurations and functions may hinder understanding of the embodiments of the present disclosure, a detailed description thereof will be omitted.

In the specification, a forward/rearward direction, a leftward/rightward direction, and a vertical direction are referred for convenience of description, and may be directions that are perpendicular to each other. However, the directions may be determined relative to a direction, in which a nozzle part is arranged, and the upward/downward direction does not necessarily refer to the vertical direction.

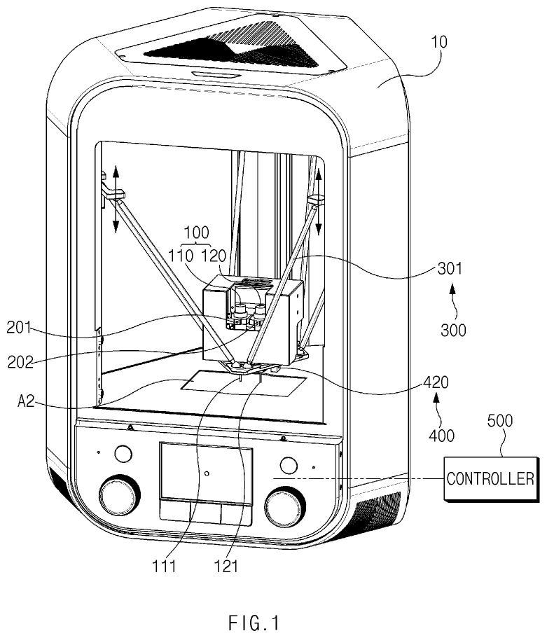

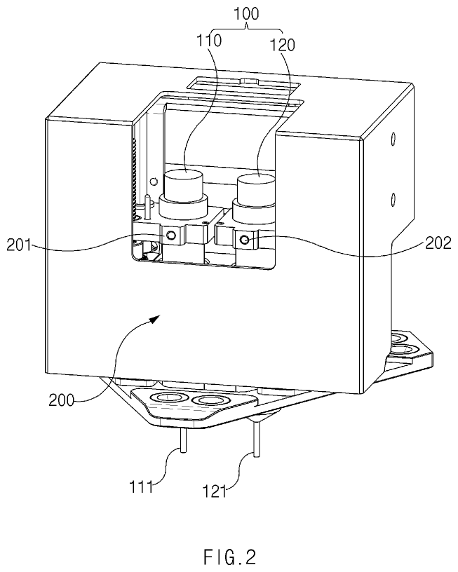

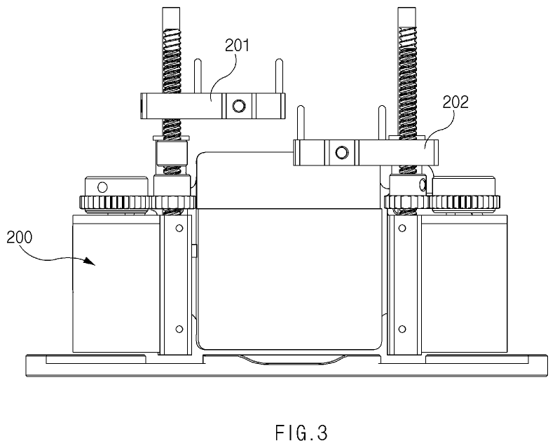

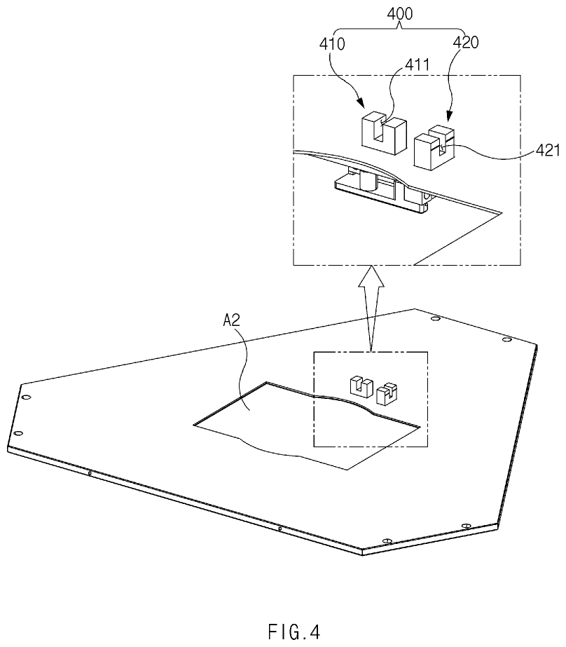

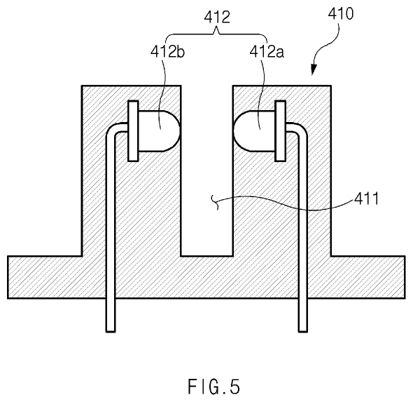

FIG. 1 is a view illustrating a nozzle calibration system according to an embodiment of the present disclosure. FIG. 2 is a view illustrating a coupling part of the nozzle calibration system according to an embodiment of the present disclosure. FIG. 3 is a view illustrating an operation principle of a first coupling portion and a second coupling portion of the coupling part while some configurations of the coupling part are omitted. FIG. 4 is a view illustrating a detection part of the nozzle calibration system according to an embodiment of the present disclosure. FIG. 5 is a view conceptually illustrating a first detection member.

The nozzle calibration system according to an embodiment of the present disclosure may be used for a 3D printer. The nozzle calibration system may be a system for measuring a location of a lower end of the needle member and setting a corresponding location as a reference point. However, it is apparent that the nozzle calibration system is not limited to the technology but may be widely applied to a field of setting a zero point of a lower end of an object having a needle shape.

### Nozzle Calibration System

The nozzle calibration system according to an embodiment of the present disclosure may include a nozzle part 100, a coupling part 200, a detection part 400, and a controller 500. The nozzle part 100 may have a needle member 101 that protrudes downwards. A bio-ink may be discharged through the needle member 101.

One or more nozzle parts 100 may be provided. As an example, the nozzle part 100 may include a first nozzle part 110 having a first nozzle member 111, and a second nozzle part 120 having a second needle member 121. However, the number of the nozzle parts 100 is not limited to two, and a larger number of nozzle parts 100 may be provided if necessary.

The coupling part 200 may be coupled to the nozzle part 100, and may be configured to move the nozzle parts 100 upwards and downwards. The coupling part 200 may mean an object, on which the nozzle parts 100 are mounted. One or more nozzle parts 100 may be mounted on the coupling part 200.

The coupling part 200 may change upward/downward locations of the first nozzle part 110 and the second nozzle part 120. As an example, the coupling part 200 may include a first coupling portion 201 and a second coupling portion 202. The first coupling portion 201 and the second coupling portion 202 may be moved upwards and downward independently of each other. A first nozzle part 110 may be coupled to the first coupling portion 201 to be moved upwards and downwards. A second nozzle part 120 may be coupled to the second coupling portion 202 to be moved upwards and downwards.

A movement part 300 may be coupled to the coupling part 200 and may be configured to move the coupling part 200. As the movement part 300 moves the coupling part 200, the nozzle part 100 is moved and a location of the needle member 101 is changed whereby bio 3D printing of a specific shape may be possible. The movement part 300 may move the coupling part 200 in all of the upward/downward direction, the leftward/rightward direction, and the forward/rearward direction. To achieve this, the movement part 300 may include six movement members 301 that are directly connected to the coupling part 200. One end of the movement member 301 may be connected to the coupling part 200 to be rotatable, and an opposite end thereof may be connected to a body 10 of a 3D printer to be moved upwards and downwards.

When the controller 500 receives an input for moving the needle member 101 to a specific location, the controller 500 may move the movement members 301 correspondingly, and may move the coupling part 200 to a specific location, at which the needle member 101 may be disposed.

The detection part 400 may be disposed in an area of the body 10 of the 3D printer, which is located on a lower side of the coupling part 200. The detection part 400 may be configured to detect information on whether the needle member 101 is located in a specific detection area A1 that is located in an interior thereof. The controller 500 may determine a time point, at which the needle member 101 is located in the detection area A1, as a zero point. Thereafter, a location of the needle member 101 may be precisely adjusted based on a distance relationship between an output area A2 for outputting a result and the corresponding detection area A1.

The detection part 400 may include a first detection member 410 and a second detection member 420. The first detection member 410 may include a first opening 411 and a first sensor 412. The first opening 411 may be opened forwards and rearwards. This may mean that an overall shape of the first detection member 410 is similar to a “U” shape.

The first sensor 412 may detect the needle member 101 when the needle member 101 passes through the first opening 411 in the forward/rearward direction. The first sensor 412 may include a first light receiving portion 412a and a first light emitting portion 412b. The first light emitting portion 412b may be located on any one of a left side or a right side of the first light receiving portion 412a and may emit light toward the first light receiving portion 412a. The first light receiving portion 412a may accommodate light that is emitted by the first light emitting portion 412b.

Assume that an area, in which the first sensor 412 detects a target object, is a first detection area. Then, the light may not be accommodated by the first light receiving portion 412a when the needle member 101 is located in the detection area such that the light is shielded. Accordingly, the controller may determine that the needle member 101 is located in the first detection area when the light is not accommodated by the first light receiving portion 412a. Accordingly, the controller 500 may record the location of the needle member 101 then, and may set the location as a reference point for a forward/rearward movement.

The second detection member 420 may include a second opening 421 and a second sensor 422. The second opening 421 may be opened leftwards and rightwards. An overall shape of the second detection member 420 may be similar to a “U” shape, and may be disposed to be perpendicular to the first detection member 410.

The second sensor 422 may detect the needle member 101 when the needle member 101 passes through the second opening 421 in the leftward/rightward direction. The second sensor 422 may include a second light receiving portion 422a and a second light emitting portion 422b. The second light emitting portion 422b may be located on any one of a front side or a rear side of the second light receiving portion 422a, and may emit light toward the second light receiving portion 422a. The second light receiving portion 422a may accommodate light that is emitted by the second light emitting portion 422b.

Assume that an area, in which the second sensor 422 detects the target object, is a second detection area. Then, the light may not be accommodated by the second light receiving portion 422a when the needle member 101 is located in the second detection area such that the light is shielded. Accordingly, the controller may determine that the needle member 101 is located in the second detection area when the light is not accommodated by the second light receiving portion 422a. Accordingly, the controller 500 may record the location of the needle member 101 then, and may set the location as a reference point for a leftward/rightward movement.

The controller 500 may be electrically connected to the coupling part 200 and the movement part 300 and may be configured to control operations of the coupling part 200 and the movement part 300. Furthermore, the controller 500 may be electrically connected to the detection part 400 and may be configured to acquire information acquired by the detection part 400.

The controller 500 may include a processor and a memory. The processor may include a microprocessor, such as a field programmable gate array (FPGA), an application specific integrated circuit (ASIC), or a central processing unit (CPU). The memory may store command instructions that are bases in processing instructions for moving the movement part 300 by the processor. The memory may be a data storage, such as a hard disk drive (HDD), a secure digital (SD), a solid state drive (SSD), a universal serial bus (USB), a volatile medium, or a nonvolatile medium.

The controller 500 may perform a first movement and a second movement. The first movement may be a movement of moving the movement part 300 such that the needle member 101 is located in the detection area A1 of the detection part 400. Through the first movement, a first reference location that will be described below may be determined.

A second movement may be a movement of calibrating an error that is generated due to a deflection of the needle member 101. The second movement may be a movement of moving the movement part 300 in a direction that crosses a movement direction of the first movement and then returning the movement part 300 such that a portion of the needle member 101 is not located in the detection area A1.

The controller 500 may set a location of the needle member 101 in the movement direction of the first movement, which is detected through the first movement, as the first reference location. For example, when it is assumed that the first movement is a forward movement, the controller may set a location of the needle member 101, which is detected through the first movement, as the first reference location with respect to a forward direction. This may be understood as primarily setting a reference point in the y axis direction.

The controller 500 may reflect a value of an error that is acquired through the second movement to the first reference location and may set the corresponding location as a second reference location. Here, the expression that the value of the error is reflected may mean that the value may be added or subtracted if necessary.

The controller 500 may set the second reference location as a reference point of the needle member 101 in the movement direction of the first movement.

Hereinafter, a method for detecting an error will be described in detail. The method for detecting an error may be a method for performing the second movement and deriving an error depending on a result.

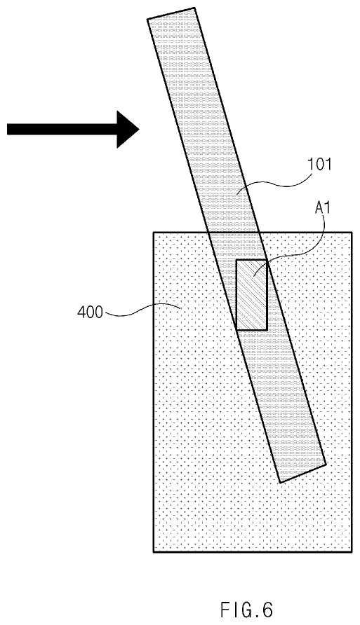

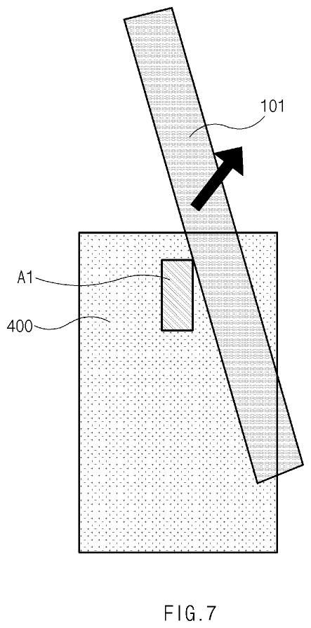

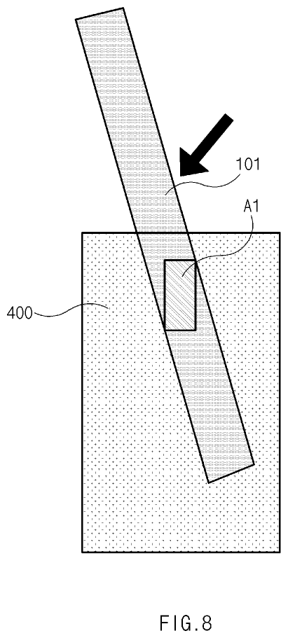

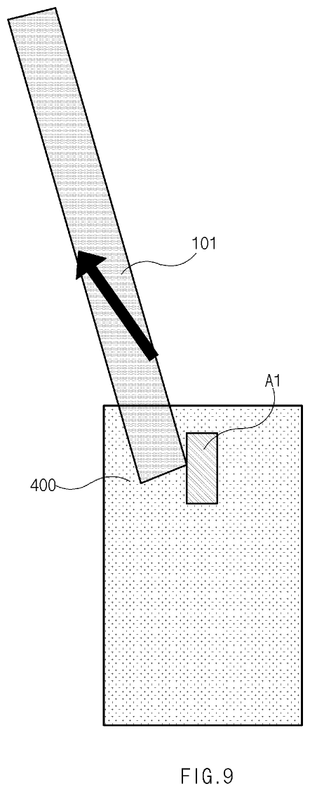

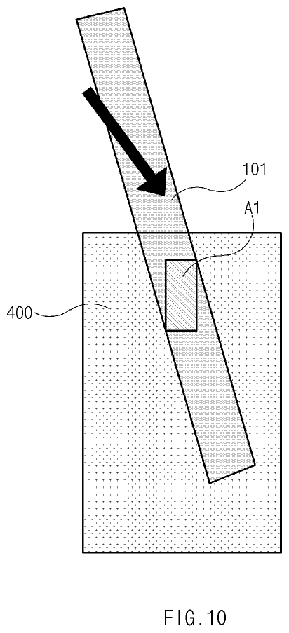

FIG. 6 is a view conceptually illustrating a state, in which the needle member performs the first movement. FIG. 7 is a view conceptually illustrating a state, in which the needle member performs a first deviation movement. FIG. 8 is a view conceptually illustrating a state, in which the needle member performs a first return movement. FIG. 9 is a view conceptually illustrating a state, in which the needle member performs a second deviation member. FIG. 10 is a view conceptually illustrating a state, in which the needle member performs a second return movement.

The second movement may include the first deviation movement, the first return movement, the second deviation movement, and the second return movement. The first deviation movement may be a movement of moving the movement part 300 in a direction crossing the movement direction of the first movement upwards at 45 degrees at the first reference location, and moving the movement part 300 until the needle member 101 is not located in the detection area A1. Then, the movement direction of the first movement may be an opening direction of, among the first opening 411 or the second opening 421, an opening, through which the needle member 101 passes.

The first return movement may be a movement of returning the movement part 300 such that the needle member 101 is located at the first reference location after the first deviation movement.

The second deviation movement may be a movement of moving the movement part 300 in a direction crossing an opposite direction to the movement direction of the first movement upwards at 45 degrees at the first reference location, and moving the movement part 300 until the needle member 101 is not located in the detection area A1.

A second return movement may be a movement of returning the needle member 101 such that the needle member 101 is located at the first reference location after the second deviation movement.

The controller 500 may acquire a displacement of the needle member 101 of the movement part 300 during the first deviation movement and the second deviation movement. Then, the error may be determined based on a displacement of the first deviation movement and a displacement of the second deviation movement.

In detail, the controller 500 may compare the displacement of the first deviation movement and the displacement of the second deviation movement, and may determine a movement direction value of the first movement, which corresponds to the greater one, as an error. For example, when FIG. 7 and FIG. 9 are compared, the controller 500 may determine a leftward/rightward component of the displacement of FIG. 9 as an error. This may be equal to a value obtained by dividing the displacement by \sqrt{2}.

The controller 500 may add the error to the first reference location when the displacement of the first deviation movement is greater, and may subtract the error from the second reference location when the displacement of the second deviation movement is greater. As illustrated in FIG. 9, when the deviation of the second deviation movement is greater, it may mean that the needle member 101 is deflected in the movement direction of the first movement. Accordingly, an end of the needle member 101 is located on the movement direction of the first movement, and a location of the end is a positive value with reference to a location of a current zero point. Accordingly, the error has to be subtracted to adjust the location of the end having a positive value to the zero point.

Meanwhile, because only a component in one direction may be determined when one detection part 400 is passed through, a movement of passing the first detection member 410 and the second detection member 420 is necessary to adjust both of zero points in the x axis and the y axis. Hereinafter, this will be described in detail.

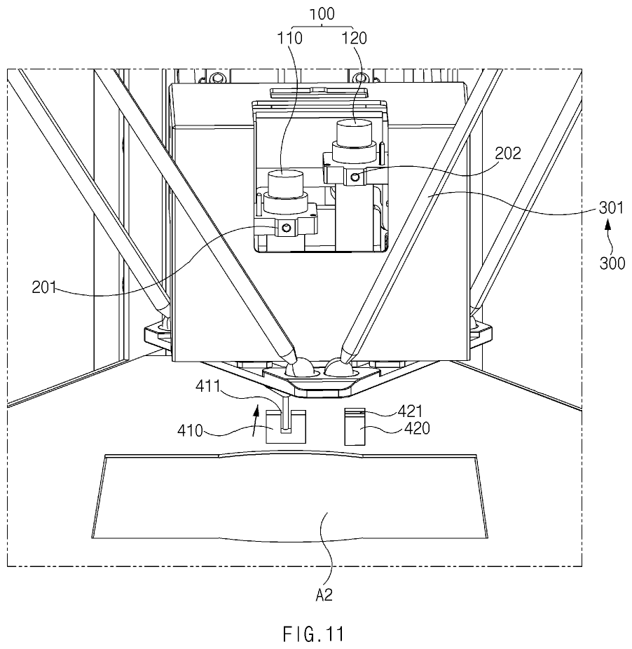

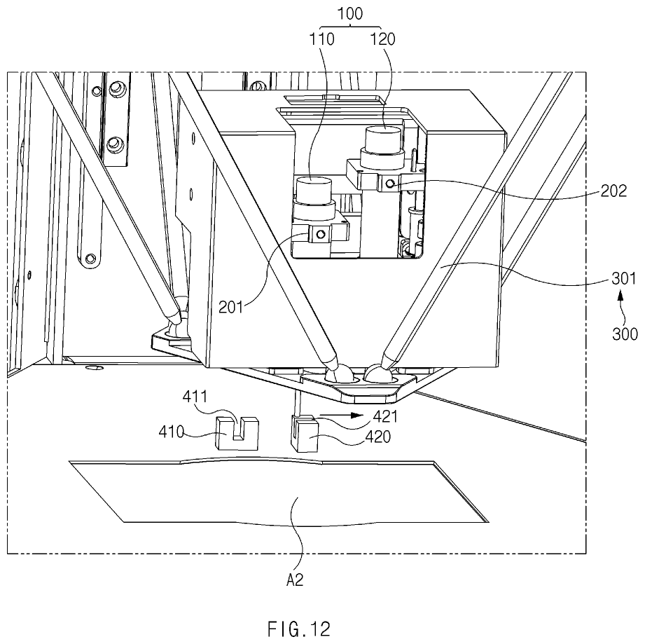

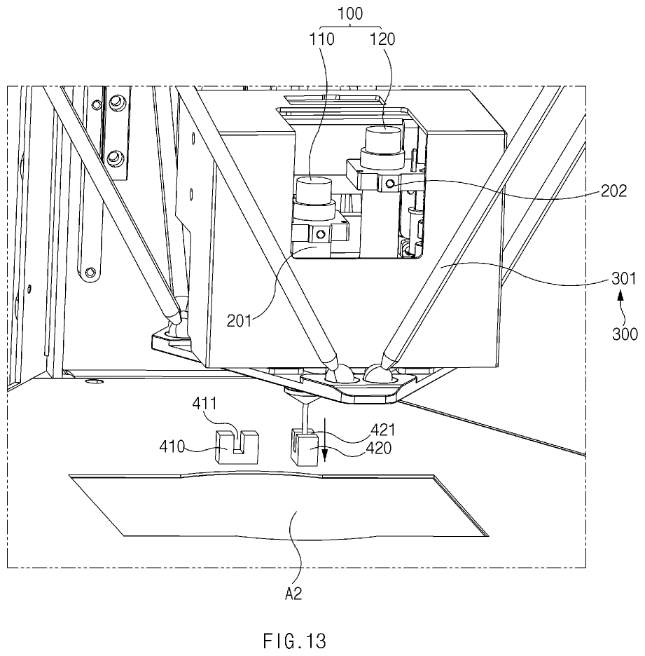

FIG. 11 is a view illustrating a state, in which a first needle member performs a (1-1)-th movement. FIG. 12 is a view illustrating a state, in which the first needle member performs a (1-2)-th movement. FIG. 13 is a view illustrating a state, in which the first needle member performs a third movement.

The first movement may include a (1-1)-th movement and a (1-2)-th movement. The (1-1)-th movement may be a movement of moving the movement part 300 forwards or rearwards such that the needle member 101 passes through the first detection area. The first detection area may be an area, in which the first sensor 412 detects the target object.

The (1-2)-th movement may be a movement of moving the movement part 300 leftwards or rightwards such that the needle member 101 passes through a second detection area. The second detection area may be an area, in which the second sensor 422 detects the target object.

However, the description of (1-1)-th and (1-2)-th are simply a description for naming, and does not limit a sequence thereof. This will be described below.

The second movement may include a (2-1)-th movement and a (2-2)-th movement. The (2-1)-th movement may be performed after the (1-1)-th movement and may be a movement of calibrating a first error. The first error may be an error that is generated in the needle member 10 due to a deflection to a front side or a rear side of the upward/downward direction.

The (2-2)-th movement may be performed after the (1-2)-th movement and may be a movement of calibrating a second error. The second error may be an error that is generated in the needle member 101 due to a deflection to a left side or a right side of the upward/downward direction.

The controller 500 may set a location of the needle member in the forward/rearward direction, which is detected through the (1-1)-th movement, as a (1-1)-th reference location, and may reflect a value of an error acquired through the (2-1)-th movement to the (1-1)-th reference location to set the corresponding location as a forward/rearward reference point.

Furthermore, the controller 500 may set a location of the needle member in a leftward/rightward direction, which is detected through the (1-2)-th movement, as a (1-2)-th reference location; and may reflect a value of an error acquired through the (2-2)-th movement to the (1-2)-th reference location, and set the corresponding location as a leftward/rightward reference point.

Next, a third movement of setting a reference point in the upward/downward direction will be described in detail.

The controller 500 may perform the third movement. The third movement may be a movement of moving the nozzle part 100 downwards after the second movement is ended.

The controller 500 may set a location of the needle member 101 in the upward/downward direction as an upward/downward reference point when the lower end of the needle member 101 is located in the detection area A1. Because the zero points of the x axis and the y axis, except for the upward/downward direction, is set through the above-described second movement, a time point, at which the corresponding zero point is moved upwards and downwards and is located in the detection area A1 may be regarded as a zero point of the z axis, that is, a reference point in the upward/downward direction.

The third movement may be performed after the (2-1)-th movement or the (2-2)-th movement is ended. As an example, the third movement may be performed after, among the (2-1)-th movement or the (2-2)-th movement, the movement that is performed later.

The controller 500 may set the location of the needle member 101 in the upward/downward direction when the lower end of the needle member 101 is located in the first detection area as an upward/downward reference point, when the third movement is performed after the (2-1)-th movement is ended.

The controller 500 may set the location of the needle member 101 in the upward/downward direction when the lower end of the needle member 101 is located in the second detection area as an upward/downward reference point, when the third movement is performed after the (2-2)-th movement is ended.

Meanwhile, as described above, when a plurality of the nozzle part 100 are provided, the above-described first to third movements may be performed on the nozzle parts 100. Hereinafter, a scheme of determining respective reference points when a first nozzle part 110 and a second nozzle part 120 are present.

The controller 500 may control the coupling part 200 to move the first nozzle part 110 downwards and the second nozzle part 120 upwards when a reference point of the first needle member 111 is determined. Then, the first coupling portion 201 may be moved downwards, and the second coupling portion 202 may be moved upwards.

Furthermore, the controller 500 may control the coupling part 200 to move the second nozzle part 120 downwards and move the first nozzle part 110 upwards when a reference point of the second needle member 121 is determined. Then, the first coupling portion 201 may be moved upwards, and the second coupling portion 202 may be moved downwards.

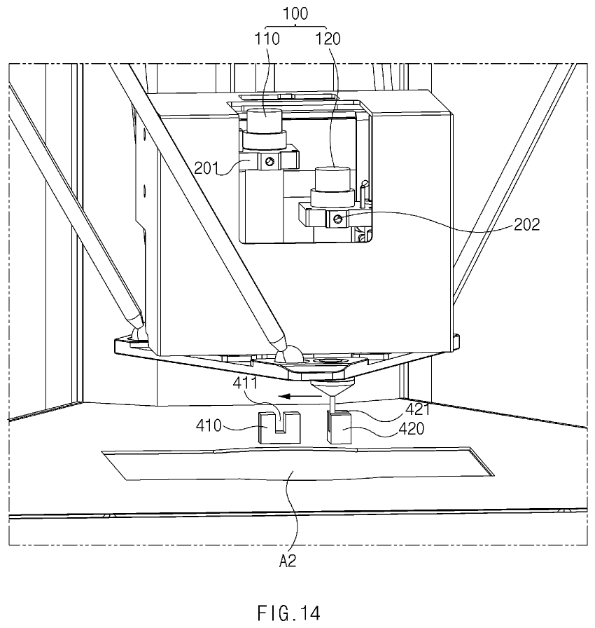

FIG. 14 is a view illustrating a state, in which a second needle member performs a (1-2)-th movement. FIG. 14 is a view illustrating a state, in which the second needle member performs a (1-1)-th movement. FIG. 14 is a view illustrating a state, in which the second needle member performs a third movement.

The controller 500 may perform any one of the (1-1)-th movement and the (1-2)-th movement first when the reference point of the first needle member is determined, and perform the other one of the (1-1)-th movement and the (1-2)-th movement first when the reference point of the second needle member is determined. This is for the efficiency of flows. As an example, when the reference point of the first needle member 111 is determined, the (1-1)-th movement may be performed first. Then, when the reference point of the second needle member 121 is determined, the (1-2)-th movement may be performed first.

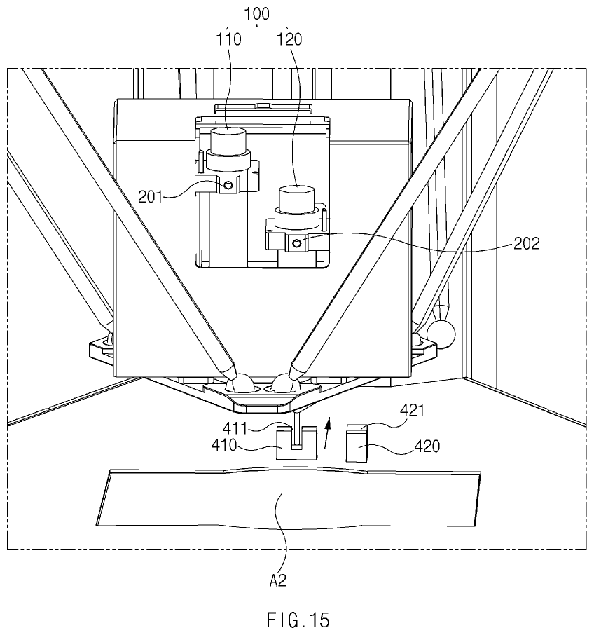

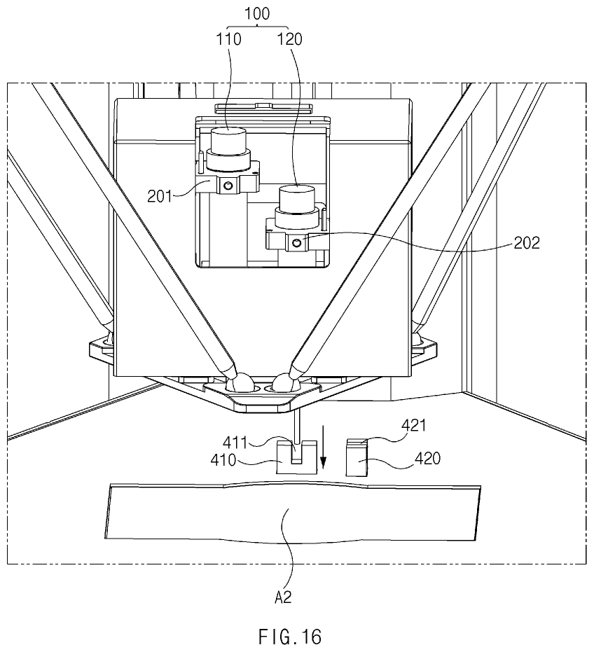

The reason why FIGS. 11 to 16 are regarded as being continuous may be understood as a process of determining the reference point of the first needle member 111 and determining the reference point of the second needle member 121. Then, the (2-1)-th movement and the (2-2)-th movement are omitted, but may be performed after the (1-1)-th movement and the (1-2)-th movement.

### Nozzle Calibration Method

Hereinafter, a nozzle calibration method for measuring the location of the lower end of the needle member 101 of the nozzle part 100 and setting the corresponding location as a reference point will be described based on the above-described contents.

The nozzle calibration method may include a first movement operation and a second movement operation. The first movement operation may be an operation of moving the nozzle part 100 such that the needle member 101 is located in the detection area A1 of the detection part 400. The second movement operation may be an operation of calibrating an error that is generated due to a deflection of the needle member 101. The second movement operation may be an operation including a process of moving the needle member 101 in a direction crossing the movement direction of the first movement operation such that a portion of the needle member 101 is not located in the detection area A1.

According to the present disclosure, because the location of the lower end of the needle is calibrated by reflecting an error value generated depending on a deflection degree of the needle, a precision may be further improved whereby a precise object may be 3D-printed.

The above description is a simple exemplary description of the technical spirits of the present disclosure, and an ordinary person in the art, to which the present disclosure pertains, may make various corrections and modifications without departing from the essential characteristics of the present disclosure. Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. A nozzle calibration system for measuring a location of a lower end of a needle member used for a 3D printer to set the location to a reference point, the nozzle calibration system comprising:
a nozzle part having the needle member protruding downwards;
a coupling part coupled to the nozzle part, and configured to move the nozzle part upwards and downwards;
a movement part coupled to the coupling part, and configured to move the coupling part;
a detection part configured to detect information on whether the needle member is located in a specific detection area located in an interior thereof; and
a controller electrically connected to the coupling part and the movement part to control an operation of the coupling part and the movement part, and electrically connected to the detection part to acquire information acquired by the detection part,
wherein the controller performs:
a first movement of moving the movement part such that the needle member is located in the detection area of the detection part; and
a second movement of moving the movement part in a direction crossing a movement direction of the first movement and returning the movement part such that a portion of the needle member is not located in the detection area, to calibrate an error generated due to deflection of the needle member.

2. The nozzle calibration system of claim 1, wherein the controller is configured to:
set a location of the needle member in the movement direction of the first movement, which is detected through the first movement, as a first reference location;
reflect a value of an error acquired through the second movement to the first reference location and set a location corresponding thereto as a second reference location; and
set the second reference location as a reference point of the needle member in the movement direction of the first movement.

3. The nozzle calibration system of claim 2, wherein the detection part includes:
a first detection member including a first opening opened forwards and rearwards, and a first sensor configured to detect the needle member when the needle member passes through the first opening in a forward/rearward direction; and
a second detection member including a second opening opened leftwards and rightwards, and a second sensor configured to detect the needle member when the needle member passes through the second opening in leftward/rightward direction.

4. The nozzle calibration system of claim 3, wherein the first movement includes:
a (1-1)-th movement of moving the movement part forwards or rearwards such that the movement part passes through a first detection area being an area, in which a target object is detected by the first sensor; and
a (1-2)-th movement of moving the movement part leftwards or rightwards such that the movement part passes through a second detection area being an area, in which the target object is detected by the second sensor, and
wherein the second movement includes:
a (2-1)-th movement performed after the (1-1)-th movement, and of causing the needle member to calibrate a first error generated due to a deflection on a front side or a rear side of an upward/downward direction; and
a (2-2)-th movement performed after the (1-2)-th movement, and of causing the needle member to calibrate a second error generated due to a deflection on a left side or a right side of the upward/downward direction.

5. The nozzle calibration system of claim 4, wherein the controller is configured to:
set a location of the needle member in a forward/rearward direction, which is detected through the (1-1)-th movement, as a (1-1)-th reference location;
reflect a value of an error acquired through the (2-1)-th movement to the (1-1)-th reference location, and set a location corresponding thereto as a forward/rearward reference point;
set a location of the needle member in a leftward/rightward direction, which is detected through the (1-2)-th movement, as a (1-2)-th reference location; and
reflect a value of an error acquired through the (2-2)-th movement to the (1-2)-th reference location, and set a location corresponding thereto as a leftward/rightward reference point.

6. The nozzle calibration system of claim 4, wherein the controller is configured to:
control the movement part to perform a third movement of the nozzle part downwards after the second movement is ended, and
wherein the controller is configured to:
set a location of the needle member in the upward/downward direction when the lower end or the needle member is located in the detection area as an upward/downward reference point.

7. The nozzle calibration system of claim 6, wherein the controller is configured to:
perform the third movement after the (2-1)-th movement or the (2-2)-th movement is ended;
set a location of the needle member in the upward/downward direction when the lower end of the needle member is located in the first detection area as an upward/downward reference point, when the third movement is performed after the (2-1)-th movement is ended; and
set a location of the needle member in the upward/downward direction when the lower end of the needle member is located in the second detection area as an upward/downward reference point, when the third movement is performed after the (2-2)-th movement is ended.

8. The nozzle calibration system of claim 2, wherein the second movement includes:
a first deviation movement of moving the movement part in a direction crossing the movement direction of the first movement upwards at 45 degrees at the first reference location, and moving the movement part until the needle member is not located in the detection area;
a first return movement of returning the movement part such that the needle member is located at the first reference location, after the first deviation movement;
a second deviation movement of moving the movement part in a direction crossing an opposite direction to the movement direction of the first movement upwards at 45 degrees at the first reference location, and moving the movement part until the needle member is not located in the detection area; and
a second return movement of returning the needle member such that the needle member is located at the first reference location, after the second deviation movement.

9. The nozzle calibration system of claim 8, wherein the controller is configured to:
acquire a displacement of the needle member of the movement part during the first deviation movement and the second deviation movement, and
wherein the error is determined based on a displacement of the first deviation movement and a displacement of the second deviation movement.

10. The nozzle calibration system of claim 9, wherein the controller is configured to:
compare the displacement of the first deviation movement and the displacement of the second deviation movement, and determine a movement direction value of the first movement, which corresponds to the greater one, as an error;
add the error to the first reference location when the displacement of the first deviation movement is the greater; and
subtract the error from the second reference location when the displacement of the second deviation movement is the greater.

11. The nozzle calibration system of claim 4, wherein the nozzle part includes:
a first nozzle part having a first needle member; and
a second nozzle part having a second needle member, and
wherein the coupling part is configured to change upward/downward locations of the first nozzle part and the second nozzle part.

12. The nozzle calibration system of claim 11, wherein the controller is configured to:
control the coupling part to move the first nozzle part downwards and move the second nozzle part upwards when a reference point of the first needle member is determined; and
control the coupling part to move the second nozzle part downwards and move the first nozzle part upwards when a reference point of the second needle member is determined.

13. The nozzle calibration system of claim 12, wherein the controller is configured to:
perform any one of the (1-1)-th movement and the (1-2)-th movement first when the reference point of the first needle member is determined; and
perform the other one of the (1-1)-th movement and the (1-2)-th movement first when the reference point of the second needle member is determined.

14. The nozzle calibration system of claim 4, wherein the first sensor includes:
a first light receiving portion; and
a first light emitting portion located on any one of a left side or a right side of the first light receiving portion, and configured to emit light toward the first light receiving portion, and
wherein the second sensor includes:
a second light receiving portion; and
a second light emitting portion located on any one of a front side or a rear side of the second light receiving portion, and configured to emit light toward the second light receiving portion.

15. A nozzle calibration method for measuring a location of a lower end of a needle member of a nozzle part and setting a location corresponding thereto to a reference point, the nozzle calibration method comprising:
a first movement operation of moving the nozzle part such that the needle member is located in a detection area of a detection part; and
a second movement operation of moving the needle member in a direction crossing a movement direction of the first movement operation such that a portion of the needle member is not located in the detection area, to calibrate an error generated due to deflection of the needle member,
wherein the detection part is configured to detect information on whether the needle member is located in the detection area located in an interior thereof.

16. The nozzle calibration method of claim 15, wherein when it is defined that a location of the needle member is at a first reference area when the needle member is located in the detection area,
the second movement operation includes:
a first deviation movement operation of moving the needle member in a direction crossing a direction, in which the needle member is moved, upwards at 45 degrees in the first movement operation at the first reference location, and moving the needle member until the needle member is not located in the detection area;
a first return movement operation of returning the needle member to the first reference location after the first deviation movement operation;
a second deviation movement operation of moving the needle member in a direction crossing an opposite direction to the direction, in which the needle member is moved, upwards at 45 degrees in the first movement operation at the first reference location, and moving the needle member until the needle member is not located in the detection area; and
a second return movement operation of returning the needle member such that the needle member is located at the first reference location after the second deviation movement operation.
